(19) United States
(12) Patent Application Publication
(10) Pub. No.: US 2014/0019876 A1
(43) Pub. Date: Jan. 16, 2014

(54) CALENDAR SYNCH WITH ANOTHER USER AND PREFERRED FREE TIME SEARCH FOR SCHEDULING AN EVENT

(71) Applicants: LIN SUN, Morrisville, NC (US); WILLIAM GAIL STODDARD, CARY, NC (US)

(72) Inventors: LIN SUN, Morrisville, NC (US); WILLIAM GAIL STODDARD, CARY, NC (US)

(73) Assignee: INTERNATIONAL BUSINESS MACHINES CORPORATION, Armonk, NY (US)

(21) Appl. No.: 13/546,535

(22) Filed: Jul. 11, 2012

(51) Int. Cl. G06F 3/01

(52) U.S. Cl. 715/753

(57) ABSTRACT

A method, system and computer program product for performing a synch in a calendar system and preferred free time search may include presenting a plurality of calendar time status entries of a user and at least one other user. Each calendar time status entry may correspond to a selected calendar time period. The method may also include synching at least one type of calendar time status entry of the user to at least one other type of calendar time status entry of the at least one other user for each of the at least one other type of calendar time status entries of the at least one other user. The method may further include presenting the synched calendar time status entries to the user.

### BACKGROUND

Aspects of the present invention relate to calendar systems, and more particularly to a method, system and computer program product for performing a calendar synch with another user in a calendar system and preferred free time search for scheduling events.

In certain environments, such as business environments, co-workers may want to synch, synchronize or coordinate each other's calendar to facilitate as much time as possible to schedule meetings or other events together or to work together on a project. One co-worker may be busier than another. For example a supervisor may be busier than subordinates and subordinates may want to set their calendar or schedule events with other workers based on the supervisor's calendar. Referring to FIG. 1, FIG. 1 is an illustration of the example 100 of scheduling an event between users 102 of a calendar system. In this example, user A and user B are assumed to work closely together on a project and therefore would like to have as much free time together for meeting. User C wants to schedule a meeting with user A but not with user B. User C schedules the meeting to be from 3-4 p.m. 104; however, 2-3 p.m. 106 is also an available time period for both user A and user C to meet. User B is available from 3-4 p.m. 108 but is not available from 2-3 p.m. and 4-5 p.m. Accordingly, in this example, users A and B who are working together on a project will not have any opportunity to work together at any time between 2-5 p.m. However, if the meeting between users A and C had been scheduled between 2-3 p.m., then users A and B would have been able to meet at least between 3-4 p.m. when user B is available.

### BRIEF SUMMARY

According to an aspect of the present invention, a method for performing a synch in a calendar system and preferred free time search may presenting, by a processor, a plurality of calendar time status entries of a user and at least one other user. Each calendar time status entry may correspond to a selected calendar time period. The method may also include synching, by the processor, at least one type of calendar time status entry of the user to at least one other type of calendar time status entry of the at least one other user for each of the at least one other type of calendar time status entries of the at least one other user. The method may further include presenting, by the processor, the synched calendar time status entries to the user.

According to another aspect of the present invention, a system for performing a synch in a calendar system and preferred free time search may include a processor and a module operating on the processor to present a plurality of calendar time status entries of a user and at least one other user. Each calendar time status entry corresponding to a selected calendar time period. The system may also include a module operating on the processor to synch at least one type of calendar time status entry of the user to at least one other type of calendar time status entry of the at least one other user for each of the at least one other type of calendar time status entries of the at least one other user. The system may further include a module to present the synched calendar time status entries to the user.

According to a further aspect of the present invention, a computer program product for performing a synch in a calendar system and preferred free time search may include a computer readable storage medium having computer readable program code embodied therewith. The computer readable program code may include computer readable program code configured to present a plurality of calendar time status entries of a user and at least one other user. Each calendar time status entry corresponding to a selected calendar time period. The computer readable program code may also include computer readable program code configured to synch at least one type of calendar time status entry of the user to at least one other type of calendar time status entry of the at least one other user for each of the at least one other type of calendar time status entries of the at least one other user. The computer readable program code may additionally include computer readable program code configured to present the synched calendar time status entries to the user.

### BRIEF DESCRIPTION OF THE SEVERAL VIEWS OF THE DRAWINGS

The present invention is further described in the detailed description which follows in reference to the noted plurality of drawings by way of non-limiting examples of embodiments of the present invention in which like reference numerals represent similar parts throughout the several views of the drawings and wherein:

FIG. 1 is an illustration of the example of scheduling an event between users of a calendar system.

FIG. 2 is a flow chart of an example of a method for performing a synch with another user in a calendar system and preferred free time search in accordance with an embodiment of the present invention.

FIG. 3 is a flow chart of an example of a method for performing a preferred free time search for scheduling an event in a calendar system with a user in accordance with an embodiment of the present invention.

FIG. 4A is an illustration of synching a preferred free time period with a not available time period of another user in accordance with an embodiment of the present invention.

FIG. 4B is an illustration of an example of searching for preferred free time periods of a user in a calendar system and scheduling an event with the user in accordance with an embodiment of the present invention.

FIG. 5 is a block schematic diagram of an example of a system for performing a synch with another user in a calendar system and preferred time search in accordance with an embodiment of the present invention.

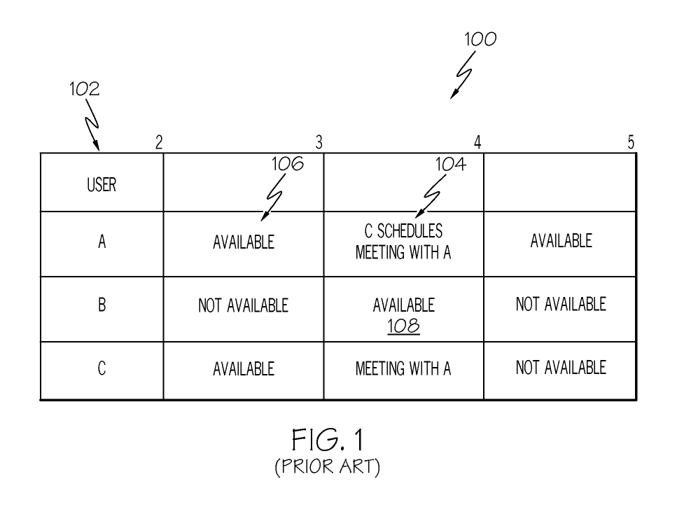

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

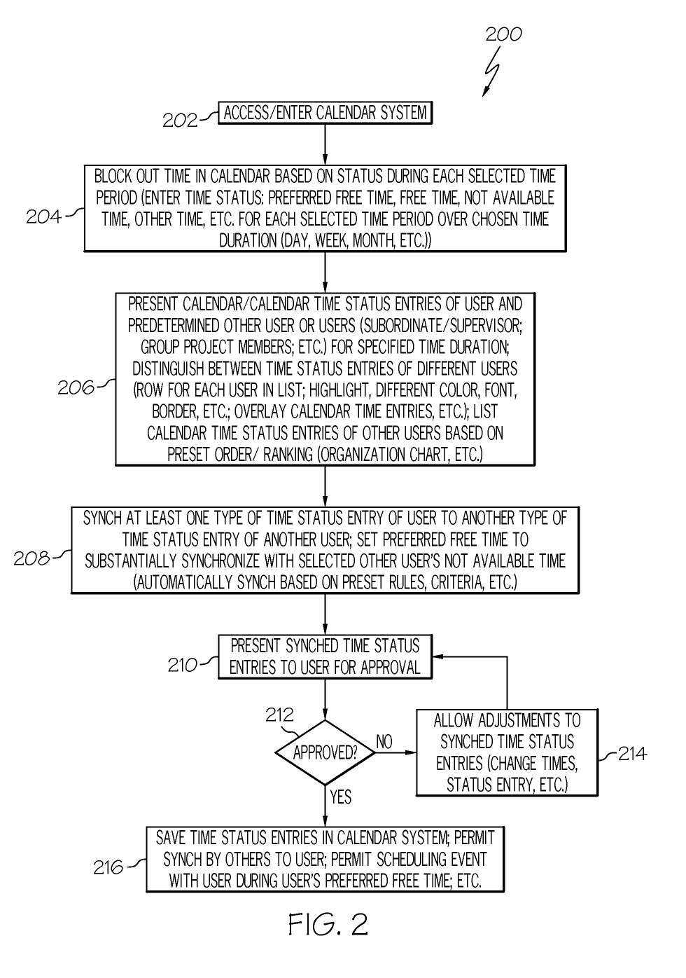

FIG. 2 is a flow chart of an example of a method 200 for performing a synch with another user in a calendar system and preferred free time search in accordance with an embodiment of the present invention. In block 202, a user may access or enter a calendar system operating on a computer system or server. The user may access the calendar system on the server over a network using a computing device. The computing device may be communications device or any type of device capable of performing the functions described herein. As described in more detail below, the network may be the Internet, private network or other type of network.

In block 204, the user may block out or enter time in a calendar of a calendar system. For example, the time may be blocked out or entered based on the user's status during each selected time period over a chosen time duration. The chosen time duration may be a portion of day, a whole day, a week, a month or any combination of these. The chosen time duration may then be divided into blocks of time or selected time periods. The selected time periods may be a portion of an hour, an hour, multiple hours or any combination of these during which the user may enter a status or calendar time status entry for the selected time period. Examples of a status or calendar time status that may be entered by the user for each selected time period may include but is not necessarily limited to “preferred free time,” “free time,” “not available” or any other identifying entry that may describe an event or activity in which the user may be engaged during the time period.

In block 206, a calendar including calendar time status entries of the user and predetermined other user or users may be presented. The predetermined other user or users may be the user's supervisor, a group of members of a project in which the user is a member, or any user or group of users to whom the user may be related in some way and desires to synchronize time status entries. Accordingly, the user may present the calendar and calendar time status entries for the user and the user's supervisor and the user and other members of group to which the user belongs.

The time status entries of the different users may be distinguished from one another. For example the time status entries of different users may be highlighted in different colors, may have a different colored font, different borders or any arrangement to distinguish between users. The highlighting may indicate a level of priority of each user. For example, the user's supervisor may be distinguished by a particular preset highlight or font color or other distinguishing feature.

The calendar and time status entries of other users may also be listed based on a preset order, such as a ranking, priority or other order. For example, the users may be listed according to level in an organization. A subordinate's supervisor may be ranked at a higher level on the list of users compared to other users at a similar organizational level or below.

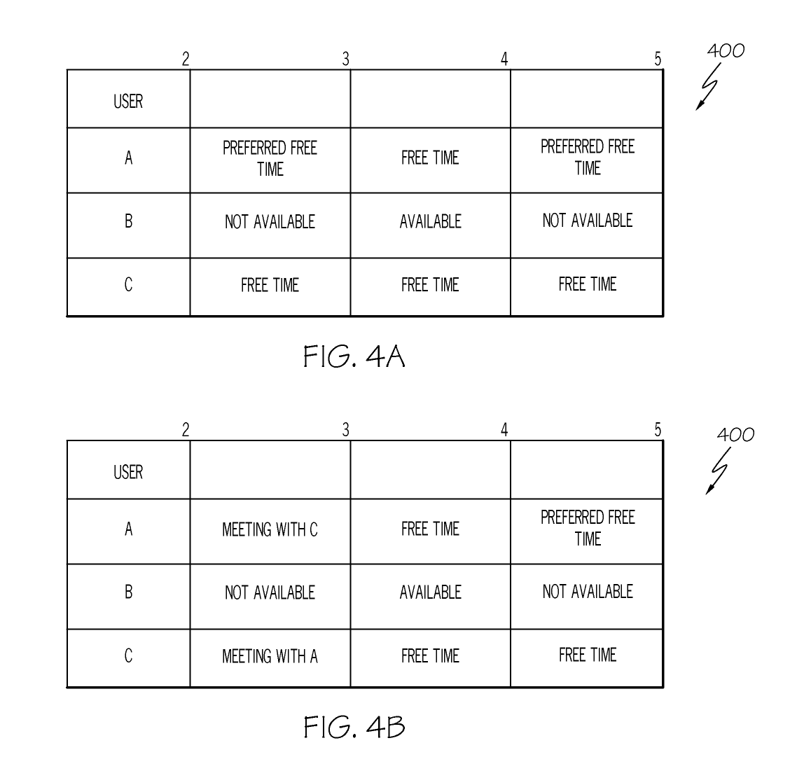

The user may specify a time duration for which the calendar and time status entries may be presented, such as for a day or portion of a day. The calendar including the calendar time status entries corresponding to selected time periods for the user and the predetermined other user or users may be presented in a tabular form similar to that illustrated in FIG. 4A. In other embodiments, the time status entries for the selected time periods may be presented in any format to facilitate viewing the combined calendar time status entries and corresponding calendar time periods of the users.

In block 208, at least one type of calendar time status entry of the user may be synchronized to at least one other type of calendar time status entry of at least one other user for each of the at least one other type calendar time status entries of the at least one other user. Synchronizing the time status entries may include setting a preferred free time entry or preferred free time period in the user's calendar that substantially synchronizes to each not available or unavailable time entry or period of the predetermined other user or group of users, such as the user's supervisor or other users with whom the user desires to coordinate free time for scheduling events between the supervisor or other users. The calendar time status entries or time periods may be substantially synchronized because one user's preferred free time periods may not exactly coincide with the not available time status of another user. For example, previously scheduled events in the users' calendars may begin and end at different times and there may be partially overlapping preferred free time of the user with not available time of the other user or users.

In an embodiment, the time status entries and corresponding time periods may be automatically adjusted or set based on preset rules or other criteria. For example, a search may be conducted to determine the not available or unavailable calendar time status entries of the other user. These may then be compared to the corresponding time status entries of the user and the user's entries may be automatically changed to the “preferred free time” status entry for scheduling events with further users. The change may occur automatically without user input unless there is some rule or criteria that prevents the current time status entry from being changed or prevents the status from being changed without user approval.

Referring also to FIG. 4A, FIG. 4A is an illustration of an example of synching a preferred free time period with a not available time period of another user in accordance with an embodiment of the present invention. In FIG. 4A, user A's calendar has been synched with user B's calendar to set a preferred free time period of user A to substantially synchronize with each not available or unavailable calendar time status entry or period of user B.

In block 210, the synched time status entries may be presented to the user. A feature may be presented for the user to approve the synched time status entries of the user and predetermined other user or users. In block 212, a determination may be made if the user approved the synched time status entries. The method 200 may advance to block 214 in response to the user or not approving the synched time status entries.

In block 214, adjustments or changes to the time status entries may be performed and new settings applied to the calendar. The method 200 may then return to block 210 and the adjusted time status entries may be presented for approval by the user. The method 200 will advance to block 216 in response to the user approving the time status entries in block 212.

In block 216, the time status entries may be saved in the calendar system. Other users may be permitted to synch with the user and further users may be permitted to schedule events with the user during the user's preferred free time.

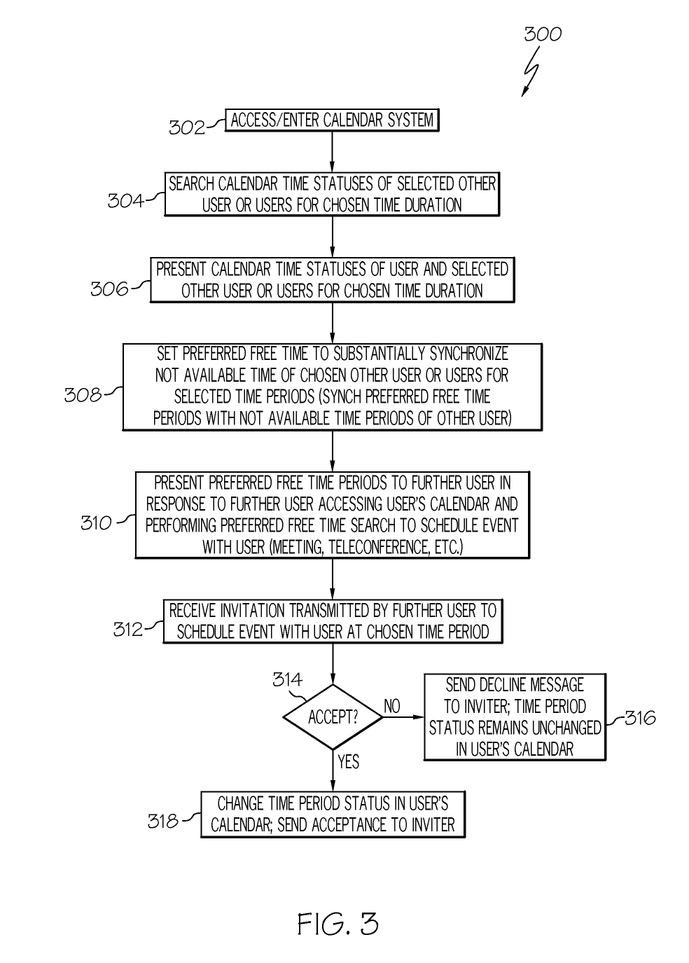

FIG. 3 is a flow chart of an example of a method 300 for performing a preferred free time search for scheduling an event in a calendar system with another user in accordance with an embodiment of the present invention. In block 302, a user may enter or access the calendar system. Similar to that previously described, the calendar system may be operating on a computer system or server. The user may access or enter the calendar system on the server via a network using a computer device or system. The computer device may be a communications device or any device capable of performing the functions and operations described herein,

In block 304, a search may be performed of calendar time statuses in the calendar system of a selected other user or users for a chosen time duration. The chosen time duration may be a portion of the day, a day, a week, a month or other chosen time duration.

In block 306, the calendar time statuses of the user and selected other user or users for the chosen time duration may be presented to the user. Referring also to FIGS. 4A and 4B, FIG. 4A is an illustration of an example of a calendar 400 or presentation of calendar time statuses of a user (user A) and selected other users (users B and C) for a chosen time duration in accordance with an embodiment of the present invention. FIG. 4B is an illustration of an example of searching for preferred fee time periods of a user in a calendar system and scheduling an event, such as a meeting, with the user in accordance with an embodiment of the present invention.

In block 308, a “preferred free time” status entry may be set or entered to substantially synchronize with “not available” or “unavailable” time period of a chosen other user or users. In the example illustrated in FIG. 4A, a preferred free time status entry may be set or entered for user A during selected time periods substantially synchronizing with each not available entry or time period of user B. Accordingly, preferred free time status entries or periods of user A may be the synched with not available time status entries or time periods of user B.

In block 310, preferred free time periods may be presented to a further user, such as user C, in response to the user C accessing user A's calendar and performing a preferred free time search to schedule an event with the user A. User C may be presented that user A's preferred free time is 2-3 p.m. and 4-5 p.m. as illustrated in the example in FIG. 4A. User C may decide to schedule the event or meeting with user A between 2-3 p.m. and may transmit an invitation to user A.

In block 312, user A may receive the invitation transmitted by user C to schedule the event with user A at a chosen time period, 2-3 p.m. In block 314, a determination may be made if user A accepted the invitation. The method 300 may advance to block 316 in response to user A declining the invitation. In block 316, a decline invitation message may be sent to the inviter or user C. The calendar time status for the chosen time period will remain unchanged in user A's calendar.

The method 300 advances to block 318 in response to user A accepting the invitation from user C in block 314. In block 318, the calendar time status for the chosen time period may change in user A's calendar to indicate the scheduled event or meeting with user C. As illustrated in FIG. 4B for user A's 2-3 time period may be changed from “preferred free time” to “meeting with C.”. User C's 2-3 p.m. time status entry may also be changed from “free time” in FIG. 4A to “meeting with A” in FIG. 4B. An acceptance message may also be sent to the inviter or user C in block 318.

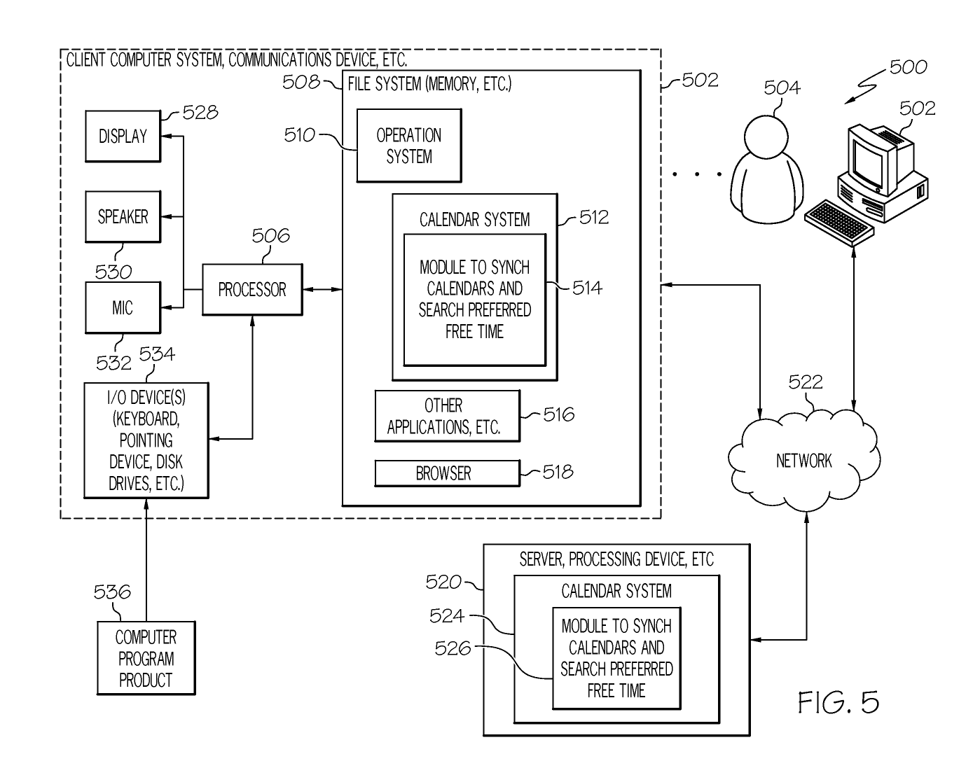

FIG. 5 is a block schematic diagram of an example of a system 500 for performing a synch with another user in a calendar system and preferred time search in accordance with an embodiment of the present invention. The methods 200 and 300 and other exemplary features described herein may be embodied in or performed by the system 500 or components of the system 500 as described below. The system 500 may include a computer system 502 for use by a user 504 for synching calendar time status entries and searching for preferred free time periods of a user in a calendar system for scheduling an event similar to those operations described herein. The computer system 502 may be any type of computer device or communications device capable of performing the functions or operations described herein.

The computer system 502 may include a processor 506 to control operation of the computer system 502 and a file system 508, memory or similar data storage device. An operating system 510 may be stored on the file system 508 for running or operating on the processor 506. A calendar system 512 may be stored on the file system 508 for operation on the processor to perform the functions and operations described herein. The calendar system 512 may include a module 514 to synch calendar time entries and search preferred free time for scheduling events. In another embodiment, the module 514 may be a separate component from the calendar system 512 but operates in association or coordination with the calendar system 512 similar to that described herein. The method 200 and/or method 300 and other programs described herein may be embodied the module 514.

Other applications 516, software programs or the like may also be stored on the file system 508 for operation on the processor 506. A web or Internet browser 518 may also be stored on the file system 508 for accessing one or more resources, such as a server 520 via the network 522. The network 522 may be the Internet, intranet or other network.

In accordance with an embodiment, the server 520 or processing device may include a calendar system 524 including a module 526 to synch calendar time entries and search preferred free time for scheduling events. The calendar system 520 and module 526 may be the same as the calendar system 512 and module 514 on computer system 502. The calendar system 524 and module 526 on the server 520 may be provided in addition to the calendar system 512 module 514 on the computer system 502. In another embodiment, only the calendar system 524 and the module 526 on the server 520 may be provided, such as in a cloud computing environment or similar arrangement. The calendar system 524 and the module 526 would then be accessed via the network 522 using the browser 518 of the computer system or computing device 502. In a further embodiment, the calendar system 512 and module 514 may perform some of the operations described herein and the calendar system 524 and module 526 on the server 520 may perform other functions described herein.

The computer system 502 may also include a display 528 for presenting calendars and synched calendar entries and other information similar to that described herein. The computer system 502 may also include a speaker system 530 for presenting any audio content. The computer system 502 may additionally include a microphone 532 for the user 504 to aurally communicate via the computer system 502.

The computer system 502 may further include one or more input devices, output devices or combination input/output devices, collectively I/O devices 534. The I/O devices 534 may include a keyboard, pointing device, such as a mouse or other computer pointing device, disk drives and any other devices to permit a user, such as user 504, to interface with and control operation of the computer system 502 and network resources, such as server 520. The calendar system 512 and module 514 may be loaded on the computer system 502 from a computer program product, such as computer program product 536 using one of the input devices 534. The computer program product 536 may be embodied in a form similar that previously described.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to embodiments of the invention in the form disclosed. Many modifications and variations will be apparent to those of ordinary skill in the art without departing from the scope and spirit of embodiments of the invention. The embodiment was chosen and described in order to best explain the principles of embodiments of the invention and the practical application, and to enable others of ordinary skill in the art to understand embodiments of the invention for various embodiments with various modifications as are suited to the particular use contemplated.

Although specific embodiments have been illustrated and described herein, those of ordinary skill in the art appreciate that any arrangement which is calculated to achieve the same purpose may be substituted for the specific embodiments shown and that embodiments of the invention have other applications in other environments. This application is intended to cover any adaptations or variations of the present invention. The following claims are in no way intended to limit the scope of embodiments of the invention to the specific embodiments described herein.

What is claimed is:

1. A method for performing a synch in a calendar system and preferred free time search, the method comprising:
presenting, by a processor, a plurality of calendar time status entries of a user and at least one other user, each calendar time status entry corresponding to a selected calendar time period;
synching, by the processor, at least one type of calendar time status entry of the user to at least one other type of calendar time status entry of the at least one other user for each of the at least one other type of calendar time status entries of the at least one other user; and
presenting, by the processor, the synched calendar time status entries to the user.

2. The method of claim 1, wherein synching the at least one type of calendar time status entry of the user to the at least one other type of calendar time status entry of the at least one other user comprises setting a preferred free time period of the user to substantially synchronize to each not available time period of the at least one other user.

3. The method of claim 2, further comprising permitting scheduling an event with the user during at least one of the preferred free time periods of the user.

4. The method of claim 2, further comprising presenting the preferred free time periods of the user to a further user in response to the further user performing a preferred free time search to schedule an event with the user.

5. The method of claim 4, further comprising receiving an invitation from the further user to schedule the event at a chosen time period.

6. The method of claim 5, further comprising changing the calendar time status entry of the user at the chosen time period in the calendar system to indicate the scheduling of the event in response to the user accepting the invitation.

7. The method of claim 1, further comprising allowing adjustments to the synched calendar time status entries of the user relative to the calendar time status entries of the at least one other user.

8. The method of claim 7, allowing the user to approve the synched time status entries.

9. The method of claim 8, further comprising saving the adjusted time status entries in the calendar system in response to the user approving the adjusted time status entries.

10. The method of claim 9, further comprising permitting further users to synch with the calendar time status entries of the user.

11. The method of claim 1, entering one of a plurality of different calendar time status entries for at least one selected time period over a chosen time duration.

12. The method of claim 11, wherein the plurality of different calendar time status entries comprises a preferred free time and a not available time.

13. The method of claim 12, further comprising setting the preferred free time of the user to substantially synchronize with each not available time of the at least one other user.

14. A system for performing a synch in a calendar system and preferred free time search, the system comprising:
a processor;
a module operating on the processor to present a plurality of calendar time status entries of a user and at least one other user, each calendar time status entry corresponding to a selected calendar time period;
a module operating on the processor to synch at least one type of calendar time status entry of the user to at least one other type of calendar time status entry of the at least one other user for each of the at least one other type of calendar time status entries of the at least one other user; and
a module to present the synched calendar time status entries to the user.

15. The system of claim 14, wherein the module to synch the at least one type of calendar time status entry of the user to the at least one other type of calendar time status entry of the at least one other user comprises a module to set a preferred free time period of the user to substantially synchronize to each not available time period of the at least one other user.

16. The system of claim 15, further comprising a module to permit scheduling an event with the user during at least one preferred free time period of the user.

17. The system of claim 15, further comprising a module for presenting the preferred free time periods of the user to a further user in response to the further user performing a preferred free time search to schedule an event with the user.

18. A computer program product for performing a synch in a calendar system and preferred free time search, the computer program product comprising:
a computer readable storage medium having computer readable program code embodied therewith, the computer readable program code comprising:
computer readable program code configured to present a plurality of calendar time status entries of a user and at least one other user, each calendar time status entry corresponding to a selected calendar time period;
computer readable program code configured to synch at least one type of calendar time status entry of the user to at least one other type of calendar time status entry of the at least one other user for each of the at least one other type of calendar time status entries of the at least one other user; and
computer readable program code configured to present the synched calendar time status entries to the user.

19. The computer program product of claim 18, wherein the computer readable program code configured to synch the at least one type of calendar time status entry of the user to substantially match the at least one other type of calendar time status entry of the at least one other user comprises computer readable program code configured to set a preferred free time period of the user to substantially match each not available time period of the at least one other user.

20. The computer program product of claim 19, further comprising computer readable program code configured to permit scheduling an event with the user during at least one of the preferred free time periods of the user.
